(19) United States
(12) Patent Application Publication
(10) Pub. No.: US 2015/0341134 A1
(43) Pub. Date: Nov. 26, 2015

(54) SIGNAL PROCESSING APPARATUS AND METHOD

(71) Applicant: Electronics and Telecommunications Research Institute, Daejeon (KR)

(72) Inventors: Chan Bok JEONG, Daejeon (KR); Young Ha LEE, Daejeon (KR); Pyeong Jung SONG, Daejeon (KR)

(73) Assignee: Electronics and Telecommunications Research Institute, Daejeon (KR)

(21) Appl. No.: 14/665,295

(22) Filed: Mar. 23, 2015

(30) Foreign Application Priority Data
May 26, 2014 (KR) 10-2014-0063291

(51) Int. Cl. H04J 13/18; H04J 13/12; H04J 13/00; H04W 72/04; H04L 27/26

(52) U.S. Cl. CPC H04J 13/18; H04W 72/042; H04L 27/2628; H04J 13/004; H04J 13/12

(57) ABSTRACT

An exemplary embodiment of the present invention provides a method for a communication apparatus to process a signal. A first processor of the communication apparatus performs symbol mapping on a first baseband signal transmitted via a PDSCH (physical downlink shared channel). The first processor sends the mapped first baseband signal to a second processor of the communication apparatus by interfacing with the second processor. The second processor modulates the sent first baseband signal. The second processor converts the modulated first baseband signal into an intermediate frequency signal.

### CROSS-REFERENCE TO RELATED APPLICATION

This application claims priority to and the benefit of Korean Patent Application No. 10-2014-0063291 filed in the Korean Intellectual Property Office on May 26, 2014, the entire contents of which are incorporated herein by reference.

### BACKGROUND OF THE INVENTION

(a) Field of the Invention

The present invention relates to a signal processing apparatus and method for signal transmission and reception.

(b) Description of the Related Art

Communication systems are evolving into low-power base station systems such as RRH (Remote Radio Head). A low-power base station system such as RRH may include a downsized, lightweight, high-efficiency antenna for a large multichannel base station and a small digital repeater. In addition, research on signal transmission methods using Massive MIMO (Multiple Input Multiple Output), i.e., a very large number of base station antennas, is underway.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an efficient signal processing method and apparatus which can be applied to a massive MIMO communication system using numerous antennas as well as to the existing communication systems.

An exemplary embodiment of the present invention provides a method for a communication apparatus to process a signal. The signal processing method includes: a first processor of the communication apparatus performing symbol mapping on a first baseband signal transmitted via a PDSCH (physical downlink shared channel); the first processor sending the mapped first baseband signal to a second processor of the communication apparatus by interfacing with the second processor; the second processor modulating the sent first baseband signal; and the second processor converting the modulated first baseband signal into an intermediate frequency signal.

The mapping may include the first processor performing symbol mapping on the first baseband signal for each codeword by using QAM (quadrature amplitude modulation).

The signal processing method may further include the first processor interfacing PDSCH control information with the second processor to send the PDSCH control information to the second processor.

The modulation may include: the second processor performing layer mapping on the sent first baseband signal by using the PDSCH control information; the second processor precoding the layer-mapped first baseband signal; and the second processor performing resource allocation on the precoded first baseband signal.

The modulation may further include: the second processor inserting a guard band into the first baseband signal with resources allocated thereto; the second processor converting the first baseband signal with the guard band by using IFFT (inverse fast Fourier transform); and the second processor adding a CP (cyclic prefix) to the IFFT-converted first baseband signal.

The conversion into an intermediate frequency signal may include the second processor converting the first baseband signal with the CP into the intermediate frequency signal.

The signal processing method may further include: the first processor modulating a second baseband signal transmitted via a first channel other than the PDSCH; the first processor allocating resources to the modulated second baseband signal; and the first processor interfacing the second baseband signal with resources allocated thereto with the second processor to send the second baseband signal with resources to the second processor.

Another exemplary embodiment of the present invention provides a method for a communication apparatus to process a signal. The signal processing method includes: a first processor of the communication apparatus converting an intermediate frequency signal into a baseband signal, for each signal reception path corresponding to an antenna; the first processor removing a guard band from the baseband signal; the first processor combining every baseband signal from which the guard band has been removed; the first processor sending the combined baseband signal to a second processor of the communication apparatus by interfacing with the second; and the second processor demodulating the sent baseband signal.

The signal processing method may further include the second processor interfacing control information for signal demodulation with the first processor to send the control information to the first processor.

The removal may include: the first processor removing a CP from the baseband signal by using the control information; the first processor converting the baseband signal from which the CP has been removed by using FFT (fast Fourier transform); and the first processor removing the guard band from the FFT-converted baseband signal.

Yet another exemplary embodiment provides a signal processing apparatus. The signal processing apparatus includes: a first signal processor that performs symbol mapping on a first baseband signal corresponding to a PDSCH, for each codeword; an interface that interfaces the symbol-mapped first baseband signal; and a second signal processor that modulates the first baseband signal sent via the interface and converts the modulated first baseband signal into a first intermediate frequency signal.

### BRIEF DESCRIPTION OF THE DRAWINGS

FIG. 1 is a view showing the configuration of a signal processing apparatus.

FIG. 2 is a view showing the configuration of a signal processing apparatus according to an exemplary embodiment of the present invention.

FIG. 3 is a sequential chart showing a signal processing process for PDSCH transmission according to an exemplary embodiment of the present invention.

FIG. 4 is a sequential chart showing a signal processing process for transmission via channels except PDSCH according to an exemplary embodiment of the present invention.

FIG. 5 is a sequential chart showing a signal processing process for signal reception according to an exemplary embodiment of the present invention.

### DETAILED DESCRIPTION OF THE EMBODIMENTS

Embodiments of the present invention will be described with reference to the accompanying drawings in order to fully describe the present invention so that a person having ordinary knowledge in the art to which the present invention pertains (hereinafter referred to as “a person skilled in the art”) can easily practice the technical spirit of the present invention. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In this specification, a base station (BS) may designate an advanced base station (ABS), a high reliability base station (HR-BS), a nodeB, an evolved nodeB (eNodeB), an access point (AP), a radio access station (RAS), a base transceiver station (BTS), a mobile multihop relay BS (MMR-BS), a relay station (RS) serving as a base station, a high reliability relay station (HR-RS) serving as a base station, etc., and may include all of part of the functions of the ABS, the nodeB, the eNodeB, the AP, the RAS, the BTS, the MMR-BS, the RS, and the HR-RS.

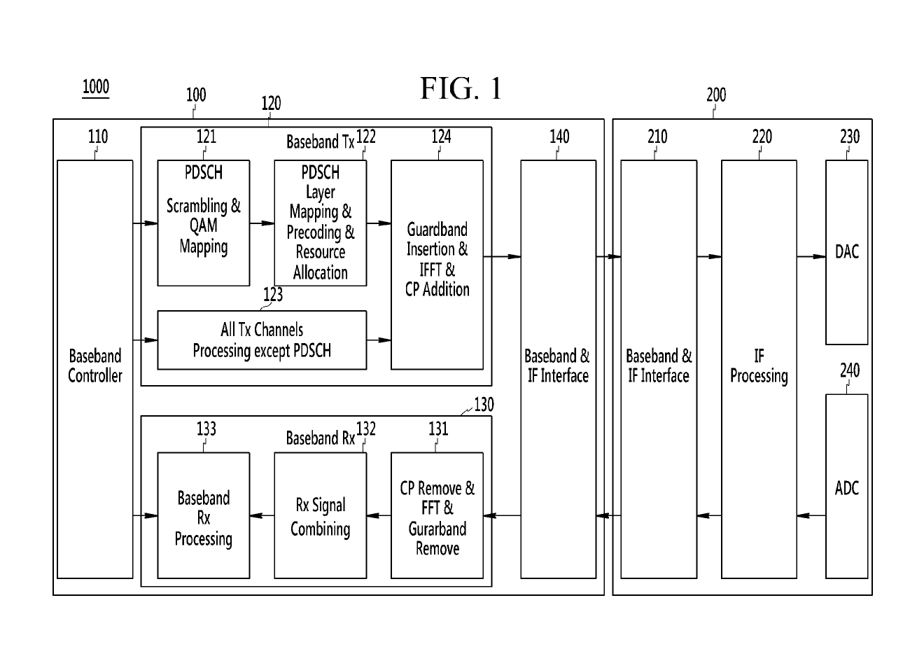

FIG. 1 is a view showing the configuration of a signal processing apparatus 1000.

The signal processing apparatus 1000 includes a baseband processor 100 and an IF (intermediate frequency) processor 200.

The baseband processor 100 is a modem (modulator and demodulator) that processes a baseband signal. Specifically, the baseband processor 100 includes a baseband controller 110, a baseband transmitter 120, a baseband receiver 130, and an interface 140.

The baseband controller 110 generates control information for signal modulation and control information for signal demodulation.

The baseband transmitter 120 modulates a baseband signal. The signal modulation functions performed by the baseband transmitter 120 include scrambling, QAM (quadrature amplitude modulation) mapping, layer mapping, precoding, resource allocation, guard band insertion, IFFT (inverse fast Fourier transform), and CP (cyclic prefix) addition. These modulation functions are well known to a person skilled in the art, so a detailed description of each modulation function will be omitted. Some or all of the modulation functions may be used according to channels. For ease of explanation, the following description will be given with an example where all of the modulation functions are used.

Specifically, the baseband transmitter 120 includes a first modulator 121, a second modulator 122, a third modulator 123, and a fourth modulator 124.

The first modulator 121 performs scrambling and QAM mapping on a baseband signal transmitted via a PDSCH (physical downlink shared channel).

The second modulator 122 performs layer mapping, precoding, and resource allocation on a signal output from the first modulator 121.

The third modulator 123 performs scrambling, QAM mapping, layer mapping, precoding, and resource allocation on a baseband signal transmitted via other transmission channels except the PDSCH.

The fourth modulator 124 performs guard band insertion, IFFT, and CP addition on a signal output from the second modulator 122 and a signal output from the third modulator 123. The interface 140 interfaces a signal output from the fourth modulator 124 to the IF processor 200. Also, the interface 140 interfaces a signal output from the IF processor 200 to the baseband receiver 130.

The baseband receiver 130 processes the signal sent from the IF processor 200 in order to demodulate the baseband signal. The signal demodulation functions performed by the baseband receiver 130 are well known to a person skilled in the art, so a detailed description of the demodulation function will be omitted. Some or all of the demodulation functions may be used according to channels. For ease of explanation, the following description will be given with an example where all of the demodulation functions are used.

Specifically, the baseband receiver 130 includes a first demodulator 131, a second demodulator 132, and a third demodulator 133.

The first demodulator 131 performs CP removal, FFT (fast Fourier transform), and guard band removal on a baseband signal sent by interfacing the interface 140 and an interface 210.

The second demodulator 132 performs signal combining on a signal output from the first modulator 131.

The third demodulator 133 demodulates a signal output from the second demodulator 132.

The IF processor 200 raises the frequency of the baseband signal to an intermediate frequency to generate an intermediate frequency signal. The IF processor 200 and the baseband processor 100 are configured independently, and work in conjunction with each other via the interfaces 140 and 210. Specifically, the IF processor 200 includes the interface 210, an IF converter 220, a DAC (digital to analog converter) 230, and an ADC (analog to digital converter) 240.

The interface 210 interfaces with the interface 140.

The IF converter 220 converts a baseband signal sent via the interface 210 into an intermediate frequency signal and sends it to the DAC 230. Also, the IF converter 220 converts a signal output from the ADC 240 into a baseband signal and sends it to the interface 210.

The DAC 230 converts a signal output from the IF converter 220 into an analog signal. Specifically, a signal output from the DAC 230 may be sent to an RF (radio frequency) processor (not shown) that converts an intermediate frequency signal into a high-frequency carrier signal. The RF processor may convert a high-frequency carrier signal received through an antenna into an intermediate frequency signal.

The ADC 240 converts an intermediate frequency signal sent from the RF processor into a digital signal and sends it to the IF converter 220.

Meanwhile, a communication system (hereinafter, ‘first communication system’) using the signal processing apparatus 1000 of FIG. 1 has no problem with a communication service provider providing general communication services, but has a problem with the provision of services using a very large number of base station antennas such as massive MIMO. Specifically, the first communication system cannot cope with the rate of interface data transfer between the baseband processor 100 and the IF processor 200 to conform to a massive MIMO service, that is, the rate of interface data transfer versus a high-capacity interface signal. Even if the first communication system can cope lo with the rate of interface data transfer conforming to the massive MIMO service, this does not guarantee stable interfacing.

Specifically, a transmitted baseband signal obtained after IFFT, i.e., a signal output from the fourth modulator 124, is sent to the IF processor 200 by interfacing the interface 140 and the interface 210, and a received baseband signal for FFT, i.e., a signal output from the IF converter 220, is sent to the baseband processor 100. The problem with the signal processing apparatus 1000 is that a very large amount of data is sent to the baseband processor 100 and the IF processor 200 by interfacing the interface 140 and the interface 210. Particularly, in a system using numerous antennas such as massive MIMO, the amount of data interfaced between the interface 140 and the interface 210 increases in proportion to the number of antennas used. For example, in an LTE (Long Term Evolution) system using 100 RBs (resource blocks), the amount (line bit rate) of data per antenna interfaced between the interface 140 and the interface 210 is as shown in the following Equation 1.

(Equation 1)

30.72[MHz]=(2048×7+160+144×6) samples×2 slots/1 ms

Line bit rate=30.72[MHz]×2(I,Q)×16 bits×10B/8B=1.2288[Gbps]

The line bit rate of Equation 1 can be obtained with reference to the following Tables 1 and 2.

TABLE 1

| Configuration | | N_{sc}^{RB} | N_{symb}^{DL} |
|---|---|---|---|
| Normal cyclic prefix | Δf = 15 kHz | 12 | 7 |
| Extended cyclic prefix | Δf = 15 kHz | | 6 |
| | Δf = 7.5 kHz | 24 | 3 |

TABLE 2

| Configuration | | Cyclic prefix length N_{CP, l} |
|---|---|---|
| Normal cyclic prefix | Δf = 15 kHz | 160 for l = 0 |
| | | 144 for l = 1, 2, . . . , 6 |
| Extended cyclic prefix | Δf = 15 kHz | 512 for l = 0, 1, . . . , 5 |
| | Δf = 7.5 kHz | 1024 for l = 0, 1, 2 |

In Table 1, N_{sc}^{RB} denotes the resource block size in the frequency domain and is expressed by the number of subcarriers. N_{symb}^{DL} denotes the number of OFDM (orthogonal frequency division multiplexing) symbols within one downlink slot.

In Table 2, I denotes an OFDM symbol index, which ranges from 0 N_{symb}^{DL} −1. In Equation 1, N_{sc}^{RB} (=12), N_{symb}^{DL} (=7) and N_{CP,I} (=160 or 144) for normal CP were used. The number of resource elements (REs) for 100 RBs is 1200 (=100×12). The signal processing apparatus 1000, when transmitting 1200 REs in one OFDM symbol, generates 2048 samples using 2048-point IFFT. Also, the signal processing apparatus 1000 adds a CP to an OFDM symbol depending on the position of the OFDM symbol, and transmits the ODM symbol over the air. A signal for 2 slots is transmitted per millisecond, the number of OFDM symbols of one slot is 7, and I=0, 1, . . . , 6.

30.72 [MHz] in Equation 1 can be obtained using the number (=7) of OFDM symbols and the 2048 samples obtained by 2048-point IFFT. In Equation 1, the same line bit rate applies to each antenna. Accordingly, if the total number of antennas used is 8 (=4 transmitting antennas+4 receiving antennas), the amount of data interfaced between the baseband processor 100 and the IF processor 200 can be obtained as in the following Equation 2.

(Equation 2)

Line bit rate=30.72[MHz]×2(I,Q)×16 bits×10B/8B×8Ant.=9.8304[Gbps]

If the total number of antennas used is 20 (=16 transmitting antennas+4 receiving antennas), the amount of data interfaced between the baseband processor 100 and the IF processor 200 can be obtained as in the following Equation 3.

(Equation 3)

Line bit rate=30.72[MHz]×2(I,Q)×16 bits×10B/8B×20 Ant.=24.576[Gbps]

As discussed above, the more antennas the signal processing apparatus 1000 uses, the larger the amount of data to be interfaced. A signal processing method and apparatus that guarantees stable interfacing are required for a communication system using a multichannel antenna as well.

If the signal processing apparatus 1000 uses a full-duplex interface for transmission and reception, such as CPRI (Common Public Radio Interface), the interface 140 and the interface 210 can interface with each other so long as the highest rate of transmission rate and reception rate can be achieved. However, any increase in the number of antennas leads to that much increase in the amount of data to be interfaced because the amount of data that can be interfaced over one CPRI is limited, and this creates the need for a number of CPRI ports.

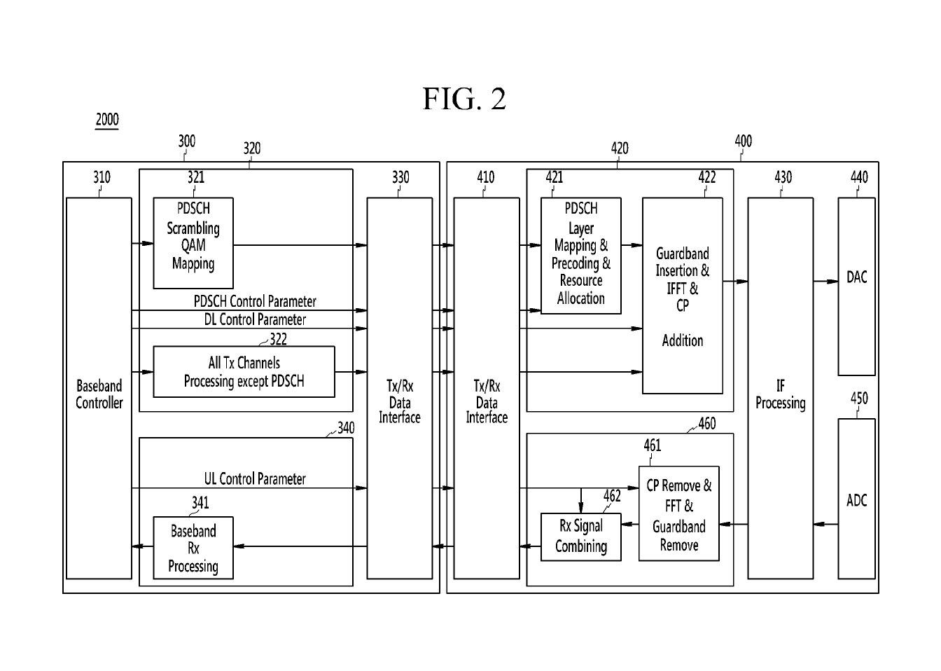

FIG. 2 is a view showing the configuration of a signal processing apparatus 2000 according to an exemplary embodiment of the present invention. For ease of explanation, the following description will be given with an example where the signal processing apparatus 2000 is applied to an LTE system or LTE-Advanced system. However, this example is only illustrative, and the signal processing apparatus 2000 can be applied to any other communication system in addition to the LTE system.

The signal processing apparatus 2000 includes a first signal processor 300 and a second signal processor 400.

The first signal processor 300 includes a baseband controller 310, a first baseband transmitter 320, a first baseband receiver 340, and an interface 330.

The baseband controller 310 generates control information for performing modulation/demodulation for each channel. Specifically, the baseband controller 310 may send control information for signal modulation to the first baseband transmitter 320 and a second baseband transmitter 420, and send control information for signal demodulation to the first baseband receiver 340 and a second baseband receiver 460.

The first baseband transmitter 320 performs part all the of modulation functions. Also, the first baseband transmitter 320 may send PDSCH control information sent from the baseband controller 310 to the interface 330. Further, lo the first baseband transmitter 320 may send downlink channel control information (used for signal modulation) sent from the baseband controller 310 to the interface 330. The PDSCH control information is baseband control information for PDSCH, and can be used for signal modulation. Specifically, the first baseband transmitter 320 may include a fifth modulator 321 and a sixth modulator 322.

The fifth modulator 321 performs scrambling and symbol mapping (e.g., QAM mapping) on each codeword of a baseband signal (corresponding to PDSCH) transmitted via the PDSCH. Specifically, a signal output from the fifth modulator 321 may be sent to the interface 330.

The sixth modulator 322 performs per-channel modulation functions, defined by the standard, on all transmission channels except the PDSCH. Specifically, the sixth modulator 322 may perform per-channel modulation functions for transmission, i.e., scrambling, QAM mapping, layer mapping, precoding, and resource allocation (for a baseband signal, for example) on a baseband signal transmitted via other transmission channels except the PDSCH. A signal output from the sixth modulator 322 may be sent to the interface 330.

The interface 330 interfaces signals output from the first baseband transmitter 320 (the signal output from the fifth modulator 321, the signal output from the sixth modulator 322, the PDSCH control information, and the downlink channel control information) to the second signal processor 400. The interface 330 sends the signals sent from the interface 410 of the second signal processor 400 to the first baseband receiver 340.

The first baseband receiver 340 performs the other demodulation functions, except the ones performed by the second baseband receiver 460. Specifically, the first baseband receiver 340 receives a baseband signal from the second signal processor 400 and processes the received baseband signal by interfacing the interface 330 and the interface 410. Also, the first baseband receiver 340 may send uplink channel control information (used for signal demodulation) sent from the baseband controller 310 to the interface 330. The interface 330 may send the received uplink channel control information to the second signal processor 400. Specifically, the first baseband receiver 340 may include a fourth demodulator 341. The fourth demodulator 341 may demodulate the baseband signal sent from the second signal processor 400 via the interface 330.

The second signal processor 400 includes an interface 410, a second baseband transmitter 420, an IF converter 430, a DAC 440, an ADC 450, and a second baseband receiver 460.

The interface 410 interfaces with the interface 330. Specifically, the interface 410 sends a baseband signal output from the first signal processor 300 and control information to the second baseband transmitter 420. Also, the interface 410 sends a baseband signal output from the second baseband receiver 460 to the interface 330. The second baseband receiver 420 performs all the other functions, except the ones performed by the first baseband transmitter 320. Specifically, the second baseband transmitter 420 may include a seventh modulator 421 and an eight modulator 422.

The seventh modulator 421 may perform layer mapping, precoding, and resource allocation on a signal output from the fifth modulator 321 sent from the interface 410, by using PDSCH control information. Specifically, the seventh modulator 421 may perform layer mapping, precoding, and resource allocation sequentially or in a different sequence.

The eighth modulator 422 may perform guard band insertion, IFFT, and CP addition on a signal output from the seventh modulator 421 and a signal output from the sixth modulator 322 and sent from the interface 410. Specifically, the eighth modulator 422 may perform guard band insertion, IFFT, and CP addition sequentially by using downlink channel control information. Also, the eighth modulator 422 may send a baseband signal with a CP to the IF converter 430.

The IF converter 430 converts a baseband signal sent from the eighth modulator 422 into an intermediate frequency signal and sends it to the DAC 440. Also, the IF converter 430 converts a signal output from the ADC 450 into a baseband signal and sends it to the second baseband receiver 460. Specifically, the IF converter 430 may convert an intermediate frequency signal into a baseband signal, for each signal reception path corresponding to a receiving antenna (hereinafter, ‘receiving antenna path’). In an LTE system or LTE-Advanced system, up to four receiving antenna paths may be provided for each transmission bandwidth.

The DAC 440 converts an intermediate frequency signal output from the IF converter 430 into an analog signal.

The ADC 450 converts an intermediate frequency signal sent from an RF processor (not shown) of the signal processing apparatus 2000 into a digital signal, and sends it to the IF converter 430.

The second baseband receiver 460 performs some of the entire demodulation functions on a baseband signal sent from the IF converter 430 by using control information. Specifically, the second baseband receiver 460 may include a fifth demodulator 461 and a sixth demodulator 462.

The fifth demodulator 461 may perform CP removal, FFT, and guard band removal on a signal for each receiving antenna path received from the IF converter 430. Specifically, the fifth demodulator 461 may perform CP removal, FFT, and guard band removal sequentially by using uplink channel control information.

The sixth demodulator 462 combines signals output from the fifth demodulator 461 (baseband signals for respective receiving antenna paths). Specifically, the sixth demodulator 462 may perform signal combining by using uplink channel control information. Also, the sixth demodulator 462 may send the combined signal to the first baseband receiver 340 by interfacing the interface 410 and the interface 330. On the other hand, the sixth demodulator 462 may not perform signal combining on a signal output from the fifth demodulator 461. In this case, the sixth demodulator 462 may send the signal output from the fifth demodulator 461 to the first baseband receiver 340 by interfacing the interface 410 and the interface 330. The first baseband receiver 340 performs the other demodulation functions except the ones performed by the second baseband receiver 460 on a baseband signal sent from the sixth demodulator 462.

The amount of data interface from the first signal processor 300 to the second signal processor 400 can be calculated as follows. In a case where the signal processing apparatus 2000 is applied to an LTE system using 100 RBs, the amount of data interfaced per codeword (the amount of data of a signal output from the fifth demodulator 321 and interfaced from the interface 330 to the interface 410) is as shown in the following Equation 4. A codeword can be mapped to a TB (Transport Block) on a one-to-one basis.

(Equation 4)

16:7[MHz]=1200 samples×7 OFDM symbolts×2 slots/1 ms.

Line bit rate=16.8[MHz]×2(I,Q)×16 bits×10B/8B=0.672[Gbps]

The signal processing apparatus 1000 of FIG. 1 performs layer mapping and precoding, and then interfaces a signal output from the fourth modulator 124 from the baseband processor 100 to the IF processor 200. After the precoding, a signal transmission path corresponding to a transmitting antenna (hereinafter, ‘transmitting antenna path’) is created. Then, the line bit rate for interfacing increases as in Equation 1, due to 2048 samples per OFDM symbol and an additional CP.

On the other hand, the signal processing apparatus 2000 interfaces a signal output from the fifth demodulator 321 from the first signal processor 300 to the second signal processor 400 before performing layer mapping and precoding. By this, the line bit rate can be reduced easily as shown in Equation 4, by eliminating interfacing for the transmitting antenna path and by using interfacing for 1200 REs corresponding to 100 RBs.

Specifically, 16.8 [MHz] in Equation 4 can be obtained using the number (=7) of transmitted OFDM symbols and 1200 samples. In Equation 4, the same line bit rate applies to each codeword. In an LTE system or LTE-Advanced system, up to two codewords can be transmitted for each bandwidth of a transmission channel. For a PDSCH channel, for example, up to two codewords can be used. Accordingly, if the number of codewords used is 2, the amount of data interfaced from the first signal processor 300 to the second signal processor 400 can be obtained as in the following Equation 5.

(Equation 5)

Line bit rate=16.8[MHz]×2(I,Q)×16 bits×10B/8B×2codewords=1.344[Gbps]

As in Equation 4 and Equation 5, the amount of data of a transmitted signal interfaced by the signal processing apparatus 2000 is much smaller than the amount of data of a transmitted signal interfaced by the signal processing apparatus 1000.

The signal processing apparatus 2000 has such a structure that interfaces from the first signal processor 300 to the second signal processor 400 regardless of the number of transmitting antennas. Accordingly, once the rate of interface data transfer of up to 1.344 [Gbps] is achieved, and PDSCH control information and a baseband signal (a signal output from the sixth modulator 322) transmitted via other channels except the PDSCH are interfaced, the signal processing apparatus 2000 is able to provide a stable interface for transmitted data.

The amount of data interfaced from the second signal processor 400 to the first signal processor 300 can be calculated as follows. The second signal lo processor 400 performs FFT, CP removal, and guard band removal for each receiving antenna path, and then combines received signals processed for respective receiving antenna paths. Also, the second signal processor 400 sends the combined signal to the first signal processor 300 by interfacing the interface 410 and the interface 310. Accordingly, in a case where the signal processing apparatus 2000 is applied to an LTE system using 100 RBs, the amount of data interfaced for each receiving antenna path (the amount of data of a signal output from the sixth demodulator 462 that is interfaced from the interfaced 410 to the interface 310) can be calculated as in the following Equation 6.

(Equation 6)

Line bit rate=16.8[MHz]×2(I,Q)×16 bits×10B/8B=0.671[Gbps]

In an LTE system or LTE-Advanced system, up to two codewords can be received for each bandwidth of a reception channel. Accordingly, if the number of codewords used is 2, the amount of data interfaced from the second signal processor 400 to the first signal processor 300 can be calculated as in the following Equation 7.

(Equation 7)

Line bit rate=16.8[MHz]×2(I,Q)×16 bits×10b/8B×2codewords=1.344[Gbps]

As in Equation 6 and Equation 7, the amount of data of a received signal interfaced by the signal processing apparatus 2000 is much smaller than the amount of data of a received signal interfaced by the signal processing apparatus 1000.

The signal processing apparatus 2000 has such a structure that it interfaces from the second signal processor 400 to the first signal processor 300 regardless of the number of receiving antennas. Accordingly, once the rate of interface data transfer of up to 1.344 [Gbps] for a PUSCH (physical uplink shared channel) is achieved, and uplink channel control information and a baseband signal received via other channels except the PUSCH are interfaced, the signal processing apparatus 2000 is able to provide a stable interface for received data.

As such, if the signal processing apparatus 2000 uses a full-duplex interface for transmission and reception, such as CPRI (Common Public Radio Interface), the highest rate of transmission rate and reception rate can be achieved. Consequently, a communication system using the signal processing apparatus 200 can provide a high-quality communication service using numerous antennas, save additional costs involved in providing a high-capacity interface, and reduce any time loss and economic losses resulting from the provision of the high-capacity interface.

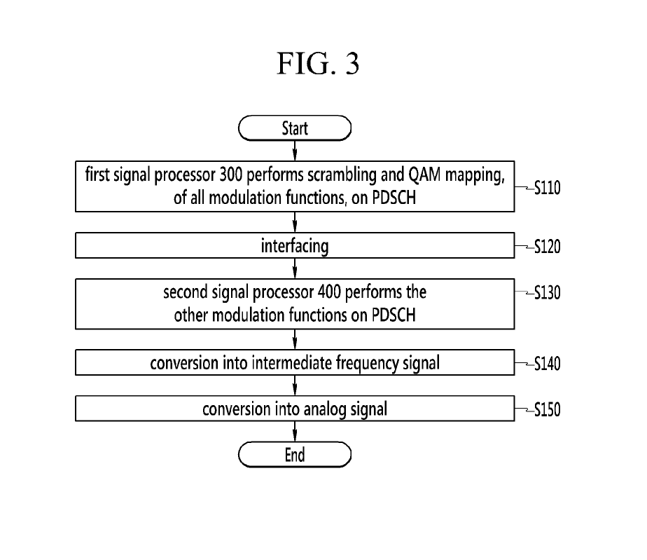

FIG. 3 is a sequential chart showing a signal processing process for PDSCH transmission according to an exemplary embodiment of the present invention.

The first signal processor 300 performs scrambling and QAM mapping, of all the modulation functions, on a baseband signal transmitted via a PDSCH (S110).

The first signal processor 300 sends the mapped baseband signal to the second signal processor 400 by interfacing the interface 330 and the interface 410 (S120). Also, the first signal processor 300 sends PDSCH control information to the second signal processor 400.

The second signal processor 400 performs layer mapping, precoding, resource allocation, guard band insertion, IFFT, and CP addition, of all the modulation functions, on the baseband signal sent in the step S120, by using

PDSCH control information (S130). Specifically, the second signal processor 400 may insert a guard band into a baseband signal with resources allocated to it, convert the baseband signal with the guard band by IFFT, and add a CP to the IFFT-converted baseband signal.

The second signal processor 400 converts the baseband signal modulated in the step S130 into an intermediate frequency signal (S140).

The second signal processor 400 converts the intermediate frequency signal into an analog signal (S150). The intermediate frequency signal, once converted into an analog signal, may be converted into a high-frequency carrier signal by an RF processor of the signal processing apparatus 2000.

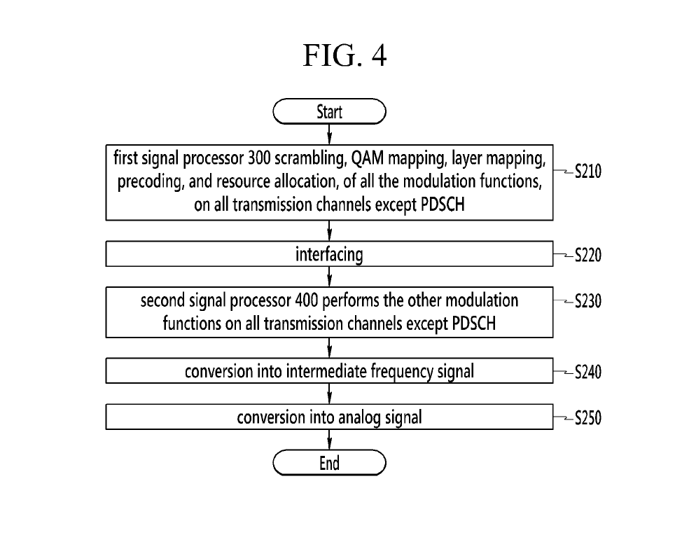

FIG. 4 is a sequential chart showing a signal processing process for transmission via channels except the PDSCH according to an exemplary embodiment of the present invention.

The first signal processor 300 performs scrambling, QAM mapping, layer mapping, precoding, and resource allocation, of all the modulation functions, on a baseband signal transmitted via transmission channels except PDSCH (S210).

The first signal processor 300 sends a baseband signal with resources allocated to it to the second signal processor 400 by interfacing the interface 330 and the interface 410 (S220).

The second signal processor 400 performs guard band insertion, IFFF, and CP addition, of all the modulation functions, on the baseband signal sent in the step S220 (S230).

The second signal processor 400 converts the baseband signal modulated in the step S230 into an intermediate frequency signal (S240).

The second signal processor 400 converts the intermediate frequency signal into an analog signal (S250). The intermediate frequency signal, once converted into an analog signal, may be converted into a high-frequency carrier signal by the RF processor.

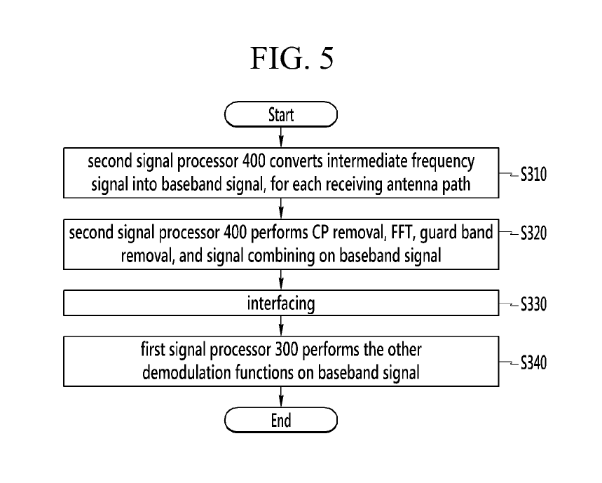

FIG. 5 is a sequential chart showing a signal processing process for signal reception according to an exemplary embodiment of the present invention.

The second signal processor 400 converts an intermediate frequency signal into a baseband signal, for each receiving antenna path (S310).

The second signal processor 400 performs CP removal, FFT, guard band removal, and signal combining, of all the demodulation functions, on the baseband signal obtained in S310 (S320). Specifically, the second signal processor 400 may remove the CP of a baseband signal for each receiving antenna path by using uplink channel control information sent from the first signal processor 300, convert each baseband signal from which the CP has been removed, by using FFT, and remove the guard band of each FFT-converted baseband signal. The second signal processor 400 may combine baseband signals processed for respective receiving antenna paths.

The second signal processor 400 sends the combined baseband signal to the first signal processor 300 by interfacing the interface 410 and the interface 330 (S330).

The first signal processor 300 performs the other demodulation functions on the baseband signal sent in the step S330 (S340).

The signal processing apparatus 200 may be a base station or a terminal.

An exemplary embodiment of the present invention relates to a structure for a baseband modem and an IF (intermediate frequency) processor. According to an embodiment of the present invention, the baseband modem and the IF processor can interface with each other regardless of the number of multichannel antennas used.

According to an embodiment of the present invention, high-quality communication service can be provided through an interfacing method which can be applied to a communication system (e.g., a massive MIMO system) using numerous antennas, as well as to a general communication system.

According to a conventional signal processing method, the amount of data interfaced between the baseband modem and the IF processor increases in proportion to the number of antennas. According to an embodiment of the present invention, however, the amount of data interfaced between the baseband modem and the IF processor may not be related to the number of antennas because it increases in proportion to the number of codewords, which is not more than a specified value (e.g., 2). By this, any additional costs of providing a high-capacity interface can be saved, and any time loss and economic losses resulting from the provision of the high-capacity interface can be reduced.

While an exemplary embodiment of the present invention has been described in detail, the protection scope of the present invention is not limited to the foregoing embodiment, and it will be appreciated by those skilled in the art that various modifications and improvements using the basic concept of the present invention defined in the appended claims are also included in the protection scope of the present invention.

What is claimed is:

1. A method for a communication apparatus to process a signal, the method comprising:
performing, by a first processor of the communication apparatus, symbol mapping on a first baseband signal transmitted via a PDSCH (physical downlink shared channel);
sending, by the first processor, the mapped first baseband signal to a second processor of the communication apparatus through interfacing with the second processor;
modulating, by the second processor, the sent first baseband signal; and
converting, by the second processor, the modulated first baseband signal into an intermediate frequency signal.

2. The method of claim 1, wherein the mapping comprises performing, by the first processor, symbol mapping on the first baseband signal for each codeword by using QAM (quadrature amplitude modulation).

3. The method of claim 1, further comprising interfacing, by the first processor, PDSCH control information with the second processor to send the PDSCH control information to the second processor,
the modulation comprising:
performing, by the second processor, layer mapping on the sent first baseband signal by using the PDSCH control information;
precoding, by the second processor, the layer-mapped first baseband signal; and
performing, by the second processor, resource allocation on the precoded first baseband signal.

4. The method of claim 3, wherein
the modulation further comprises:
inserting, by the second processor, a guard band into the first baseband signal with resources allocated thereto;
converting, by the second processor, the first baseband signal with the guard band by using IFFT (inverse fast Fourier transform); and
adding, by the second processor, a CP (cyclic prefix) to the IFFT-converted first baseband signal.

5. The method of claim 4, wherein the conversion into an intermediate frequency signal comprises converting, by the second processor, the first baseband signal with the CP into the intermediate frequency signal.

6. The method of claim 5, further comprising:
modulating, by the first processor, a second baseband signal transmitted via a first channel other than the PDSCH;
allocating, by the first processor, resources to the modulated second baseband signal; and
interfacing, by the first processor, the second baseband signal with resources allocated thereto with the second processor to send the second baseband signal with resources to the second processor.

7. A method for a communication apparatus to process a signal, the method comprising:
converting, a first processor of the communication apparatus, an intermediate frequency signal into a baseband signal, for each signal reception path corresponding to an antenna;
removing, the first processor, a guard band from the baseband signal;
combining, by the first processor, every baseband signal from which the guard band has been removed;
sending, by the first processor, the combined baseband signal to a second processor of the communication apparatus by interfacing with the second processor; and
demodulating, by the second processor, the sent baseband signal.

8. The method of claim 7, further comprising interfacing, by the second processor, control information for signal demodulation with the first processor to send the control information to the first processor.

9. The method of claim 8, wherein
the removal comprises:
removing, by the first processor, a CP (cyclic prefix) from the baseband signal by using the control information;
converting, by the first processor, the baseband signal from which the CP has been removed by using FFT (fast Fourier transform); and
removing, by the first processor, the guard band from the FFT-converted baseband signal.

10. A signal processing apparatus comprising:
a first signal processor that performs symbol mapping on a first baseband signal corresponding to a PDSCH (physical downlink shared channel), for each codeword;
an interface that interfaces the symbol-mapped first baseband signal; and
a second signal processor that modulates the first baseband signal sent via the interface and converts the modulated first baseband signal into a first intermediate frequency signal.

11. The apparatus of claim 10, wherein the first signal processor uses QAM (quadrature amplitude modulation) for symbol mapping.

12. The apparatus of claim 11, wherein the first signal processor sends first control information for signal modulation to the second signal processor via interfacing of the interface,
and the second signal processor performs layer mapping on the first baseband signal sent via the interface by using the first control information, precodes the layer-mapped first baseband signal, and allocates resources to the precoded first baseband signal.

13. The apparatus of claim 12, wherein the second signal processor inserts a guard band into the first baseband signal with resources allocated thereto, converts the first baseband signal with the guard band by using IFFT (inverse fast Fourier transform), and adds a CP (cyclic prefix) to the IFFT-converted first baseband signal.

14. The apparatus of claim 13, wherein the second signal processor converts the first baseband signal with the CP into the first intermediate frequency signal.

15. The apparatus of claim 14, wherein the first processor modulates a second baseband signal corresponding to a first channel other than the PDSCH, allocates resources to the modulated second baseband signal, and sends the second baseband signal with resources allocated thereto to the second signal processor via interfacing of the interface.

16. The apparatus of claim 15, wherein the second signal processor inserts a guard band into the sent second baseband signal, converts the second baseband signal with the guard band by using IFFT (cyclic prefix), and adds a CP (cyclic prefix) to the IFFT-converted second baseband signal.

17. The apparatus of claim 16, wherein the second signal processor converts the second baseband signal with the CP into a second intermediate frequency signal.

18. The apparatus of claim 10, wherein the second processor converts a second intermediate frequency signal into a second baseband signal, for each signal reception path corresponding to an antenna, removes a guard band from the second baseband signal, combines every second baseband signal from which the guard band has been removed, and sends the combined second baseband signal to the first signal processor via interfacing of the interface,
and the first signal processor demodulates the sent second baseband signal.

19. The apparatus of claim 18, wherein the first signal processor sends first control information for signal demodulation to the second signal processor via interfacing of the interface.

20. The apparatus of claim 19, wherein the second signal processor removes a CP (cyclic prefix) from the second baseband signal by using the first control information, converts the second baseband signal from which the CP has been removed by using FFT (fast Fourier transform), and removes the guard band from the FFT-converted second baseband signal.
